(19) United States
(12) Patent Application Publication
(10) Pub. No.: US 2020/0090832 A1
(43) Pub. Date: Mar. 19, 2020

(54) DIRECTION INDICATING CORD ASSEMBLY

(71) Applicant: Michael Revilak, Wasilla, AK (US)

(72) Inventor: Michael Revilak, Wasilla, AK (US)

(21) Appl. No.: 16/135,049

(22) Filed: Sep. 19, 2018

(51) Int. Cl. H01B 7/02; H01B 7/04

(52) U.S. Cl. CPC H01B 7/02; H01B 7/04

(57) ABSTRACT

A direction indicating cord assembly includes a charge cord that has a first plug that is electrically coupled thereto and a second plug that is electrically coupled thereto. A textured layer is coupled around the charge cord. The textured layer has a smooth texture when the textured layer is rubbed in a first direction running between the second plug and the first plug. Alternatively, the texture layer has a rough texture when the texture layer is rubbed in a second direction running between the first plug and the second plug. In this way a user can use touch to determine the required orientation of the charge cord between an electronic device and a power source.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to directional cord devices and more particularly pertains to a new directional cord device for indicating through touch a preferred orientation of the charge cord.

### BRIEF SUMMARY OF THE INVENTION

An embodiment of the disclosure meets the needs presented above by generally comprising a charge cord that has a first plug that is electrically coupled thereto and a second plug that is electrically coupled thereto. A textured layer is coupled around the charge cord. The textured layer has a smooth texture when the textured layer is rubbed in a first direction running between the second plug and the first plug. Alternatively, the texture layer has a rough texture when the texture layer is rubbed in a second direction running between the first plug and the second plug. In this way a user can use touch to determine the required orientation of the charge cord between an electronic device and a power source.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a direction indicating cord assembly according to an embodiment of the disclosure.

FIG. 2 is a detail view taken from circle 2 of FIG. 1 of an embodiment of the disclosure.

FIG. 3 is a perspective view of an alternative embodiment of the disclosure.

FIG. 4 is a top view an alternative embodiment of the disclosure.

### DETAILED DESCRIPTION OF THE INVENTION

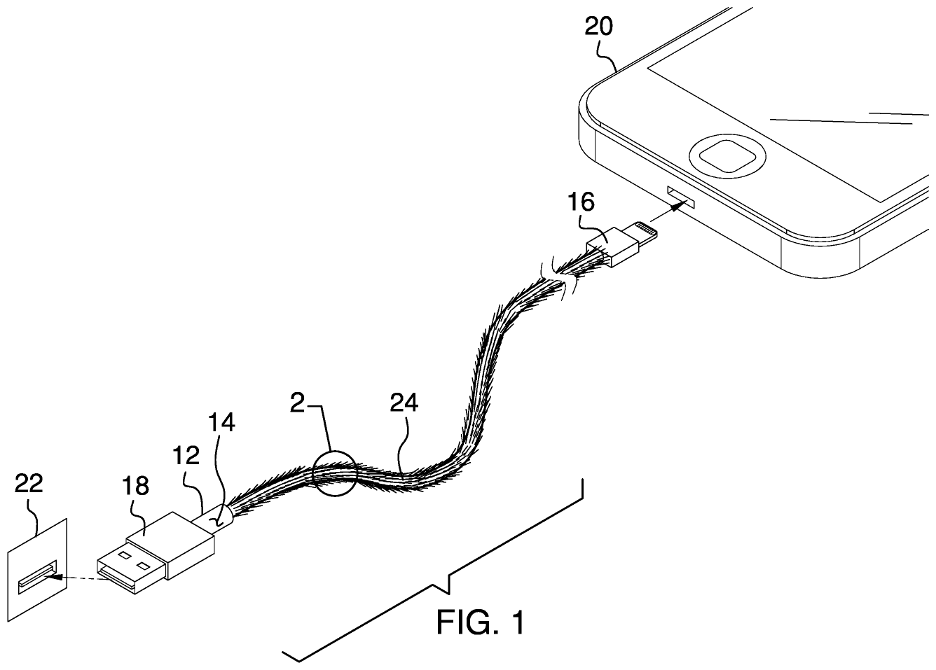

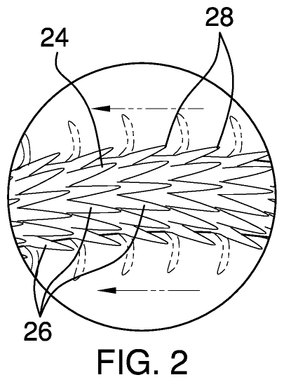

With reference now to the drawings, and in particular to FIGS. 1 through 4 thereof, a new directional cord device embodying the principles and concepts of an embodiment of the disclosure and generally designated by the reference numeral 10 will be described.

As best illustrated in FIGS. 1 through 4, the direction indicating cord assembly 10 generally comprises a charge cord 12 that has an outer surface 14. The charge cord 12 has a first plug 16 that is electrically coupled thereto and a second plug 18 that is electrically coupled thereto. The first plug 16 is positioned on an opposite end of the charge cord 12 with respect to the second plug 18. Moreover, the first plug 16 is selectively plugged into an electronic device 20 and the first plug 16 may comprise a micro usb plug, a firewire plug or other type of electronic communication plug. The second plug 18 is selectively plugged into a power source 22 and the second plug 18 may comprise a usb plug or the like. The electronic device 20 may be a smart phone or other device that has a micro usb port or a firewire port, and the power source 22 may be a usb port on a charger or the like.

A textured layer 24 is provided and the textured layer 24 is coupled around the charge cord 12. The textured layer 24 has a smooth texture when the textured layer 24 is rubbed in a first direction running between the second plug 18 and the first plug 16. Alternatively, the textured layer 24 has a rough texture when the texture layer is rubbed in a second direction running between the first plug 16 and the second plug 18. Thus, when a user rubs the textured layer 24 in the first direction the lack of friction communicates which end of the charge cord 12 should be plugged into the electronic device 20. Alternatively, when the user rubs the textured layer 24 in the second direction the presence of friction communicates which end of the charge cord 12 should be plugged into the power source 22.

The textured layer 24 is positioned around the outer surface 14 of the charge cord 12 and the textured layer 24 has a plurality of fingers 26 each extending outwardly therefrom. Each of the fingers 26 has a distal end 28 with respect to the charge cord 12 and each of the fingers 26 is comprised of a resiliently bendable material. Each of the fingers 26 angles upwardly from the charge cord 12 having the distal end 28 being directed toward the first plug 16 on the charge cord 12. Each of the fingers 26 is compressed against the textured layer 24 when the textured layer 24 is rubbed in the first direction. Thus, the textured layer 24 poses a minimum frictional resistance to being rubbed. Each of the fingers 26 is bent toward the second plug 18 when the textured layer 24 is rubbed in the second direction. Thus, the textured layer 24 poses a maximum frictional resistance to being rubbed.

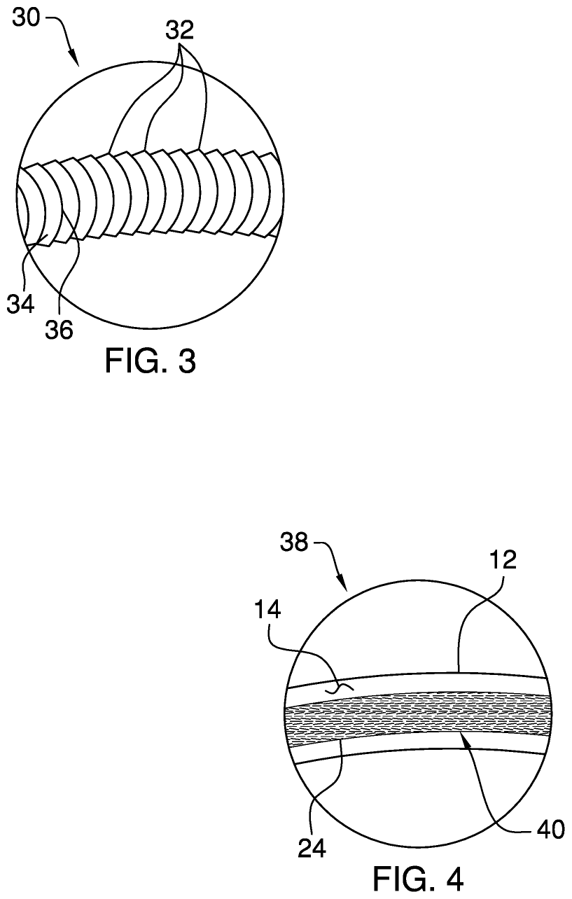

In an alternative embodiment 30 as shown in FIG. 3, the textured layer 24 has plurality of ridges 32 thereon. The ridges 32 are spaced apart from each other and are distributed between the first 16 and second 18 plugs. Each of the ridges 32 has a sloping face 34 and a vertical face 36. Additionally, the sloping face 34 slopes upwardly between the second plug 18 and the first plug 16. The user rubs along the sloping face 34 when the textured layer 24 is rubbed in the first direction. In this way the textured layer 24 poses the minimum amount of friction. The user rubs against the vertical face 36 of each of the ridges 32 when the textured layer 24 is rubbed in the second direction. In this way the textured layer 24 poses the maximum amount of friction. In an alternative embodiment 38 as shown in FIG. 4, the textured layer 24 may be presented as an elongated strip 40 running between the first 16 and second 18 plugs.

In use, the user rubs their fingers 26 along the textured layer 24 when the user grabs the charge cord 12 for connecting the charge cord 12 between the electronic device 20 and the power source 22. The textured layer 24 poses the minimum amount of friction when the textured layer 24 is rubbed in the first direction thereby communicating to the user that the user is rubbing the textured layer 24 toward the first plug 16. In this way the user is shown that that first plug 16 should be connected to the electronic device 20. The textured layer 24 poses the maximum amount of friction when the textured layer 24 is rubbed in the second direction thereby communicating to the user that the user is rubbing the textured layer 24 toward the second plug 18. In this way the user is shown that the second plug 18 should be connected to the power source 22. Thus, the textured layer 24 facilitates the user to understand the required orientation of the charge cord 12 when the charge cord 12 is gripped at night or in a darkened environment.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A direction indicating cord assembly having a textured surface for indicating which end of the cord connects to a device and which end of the cord connects to a power source, said assembly comprising:
a charge cord having a first plug being electrically coupled thereto and a second plug being electrically coupled thereto; and
a textured layer being coupled around said charge cord, said textured layer having a smooth texture when said textured layer is rubbed in a first direction running between said second plug and said first plug, said texture layer having a rough texture when said texture layer is rubbed in a second direction running between said first plug and said second plug.

2. The assembly according to claim 1, wherein said textured layer is positioned around an outer surface of said charge cord, said textured layer having a plurality of fingers each extending outwardly therefrom, each of said fingers having a distal end with respect to said charge cord, each of said fingers angling upwardly from said charge cord having said distal end being directed toward said first plug on said charge cord.

3. The assembly according to claim 2, wherein each of said fingers is compressed against said textured layer when said textured layer is rubbed in said first direction wherein said textured layer is configured to pose a minimum frictional resistance to being rubbed.

4. The assembly according to claim 3, wherein each of said fingers is bent toward said second plug when said textured layer is rubbed in said second direction wherein said textured layer is configured to pose a maximum frictional resistance to being rubbed.

5. The assembly according to claim 1, wherein said textured layer has plurality of ridges thereon, said ridges being spaced apart from each other and being distributed between said first and second plugs, each of said ridges having a sloping face and a vertical face, said sloping face sloping upwardly between said second plug and said first plug.

6. A direction indicating cord assembly having a textured surface for indicating which end of the cord connects to a device and which end of the cord connects to a power source, said assembly comprising:
a charge cord having an outer surface, said charge cord having a first plug being electrically coupled thereto and a second plug being electrically coupled thereto, said first plug being positioned on an opposite end of said cord with respect to said second plug, said first plug being selectively plugged into an electronic device, said second plug being selectively plugged into a power source; and
a textured layer being coupled around said charge cord, said textured layer having a smooth texture when said textured layer is rubbed in a first direction running between said second plug and said first plug, said texture layer having a rough texture when said texture layer is rubbed in a second direction running between said first plug and said second plug, said textured layer being positioned around said outer surface of said charge cord, said textured layer having a plurality of fingers each extending outwardly therefrom, each of said fingers having a distal end with respect to said charge cord, each of said fingers angling upwardly from said charge cord having said distal end being directed toward said first plug on said charge cord, each of said fingers being compressed against said textured layer when said textured layer is rubbed in said first direction wherein said textured layer is configured to pose a minimum frictional resistance to being rubbed, each of said fingers being bent toward said second plug when said textured layer is rubbed in said second direction wherein said textured layer is configured to pose a maximum frictional resistance to being rubbed.

7. (canceled)
